(19) United States
(12) Patent Application Publication
(10) Pub. No.: US 2009/0252109 A1
(43) Pub. Date: Oct. 8, 2009

(54) METHOD FOR DEMODULATING BROADCAST CHANNEL BY USING SYNCHRONIZATION CHANNEL AT OFDM SYSTEM WITH TRANSMIT DIVERSITY AND TRANSMITTING/RECEIVING DEVICE THEREFOR

(75) Inventors: Il-Gyu Kim, Seoul (KR); Hyeong-Geun Park, Daejeon (KR); Nam-Il Kim, Daejeon (KR); Kap-Seok Chang, Daejeon (KR); Moon-Sik Lee, Daejeon (KR); Young-Hoon Kim, Daejeon (KR); Seung-Chan Bang, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/158,868

(22) PCT Filed: Dec. 22, 2006
(86) PCT No.: PCT/KR06/05657

§ 371 Date: Jun. 23, 2008

(30) Foreign Application Priority Data
Dec. 22, 2005 (KR) 10-2005-0127703
Sep. 4, 2006 (KR) 10-2006-0084867
Dec. 1, 2006 (KR) 10-2006-0120716

(51) Int. Cl. H04W 72/04; H04J 11/00

(52) U.S. Cl. 370/330; 375/260

(57) ABSTRACT

The present invention relates to a method for demodulating a BCH by using an SCH in an OFDM system with transmit diversity, and a transmitting apparatus and a receiving apparatus using the same. For this purpose, the present invention provides a transmit diversity transmission method for a transmitting apparatus of a base station that generates an SCH symbol and a BCH symbol, maps the SCH symbol and the BCH symbol to an OFDM signal, converts the OFDM signal into a time domain signal, and transmits the OFDM signal trough a selected antenna among a plurality of antennas. In addition, the present invention provides a method for demodulating a BCH by using an SCH to a mobile station that receives an OFDM signal from the base station, filters an SCH and a BCH from the OFDM signal, converts the OFDM signal to a frequency domain signal, calculates a channel estimation value by using the SCH and the BCH, and coherently demodulates the BCH. According to the present invention, coherent demodulation of a BCH can reduce a frame error generation probability, minimize a channel estimation error due to fading, reduce time for checking the number of antennas of the base station and time for demodulating the BCH, and reduce power consumption.

### TECHNICAL FIELD

The present invention relates to a method for demodulating a broadcasting channel by using a synchronization channel in an orthogonal frequency division multiplex (OFDM) system with transmit diversity, and a transmitting/receiving apparatus using the same. More particularly, it relates to a method for a mobile station to demodulate a broadcasting channel (BCH) by using a synchronization channel (SCH) in an OFDM system, wherein the BCH and the SCH are transmitted with the same transmit diversity from a base station having a plurality of transmit antennas, and a transmitting apparatus and a receiving apparatus using the same.

### BACKGROUND ART

A fourth generation mobile communication system that requires wireless large-capacity data transmission uses an orthogonal frequency division multiplexing (OFDM) method for wideband data transmission at a high rate. The fourth generation module communication system includes a wireless local area network (WLAN), radio broadcasting, and digital multimedia broadcasting (DMB).

According to a conventional OFDM method, a mobile station acquires frame timing and long pseudo noise (PN) scrambling code information of a base station that the mobile station is accessing from a primary synchronization channel (SCH), a secondary SCH, and a pilot channel on a forward link transmitted from the base station. Such an acquisition process is called a cell search process of the mobile station. When the cell search process is completed, the mobile station must demodulate a broadcasting channel (BCH) transmitted from the base station so as to acquire system information.

In this case, the BCH is a common BCH transmitted on a forward link from multi-sector base stations, and it transmits system information to the mobile station. Herein, the system information includes system timing information such as a system frame number (SFN) and bandwidth information provided by a base station system. That is, after performing the cell search process by using the SCH, the mobile station demodulates the BCH so as to acquire basic system information.

Meanwhile, improvement in link throughput and network capacity is a main factor for achieving high-speed data transmission between the base station and the mobile station in the OFDM system. When the base station and the mobile station respectively include multiple antennas, the link throughput can be significantly increased by transmitting/receiving data through the multiple antennas. Diversity means transmitting/receiving a signal through multiple antennas between the base station and the mobile station, and the diversity can be applied when the base station transmits an OFDM signal including an SCH and a BCH to the mobile station.

That is, when the base station transmits a BCH by using a transmit antenna, transmit diversity is not applied.

When the base station transmits the BCH by using more than two transmit antennas, the transmit diversity is applied to the BCH by using a space time block coding (STBC) method.

As described, when the diversity is applied to the OFDM system, the mobile station must check whether the base station applies the transmit diversity to the BCH transmission in order to demodulate the BCH for system information acquisition.

When initial power is supplied to the mobile station, the mobile station receives a primary SCH signal from the base station. However, since the primary SCH signal does not include information on whether or not the base station has applied the transmit diversity, the mobile station cannot check whether the base station has applied the transmit diversity to the BCH transmission. The base station includes diversity information in a secondary SCH, performs binary phase shift keying (BPSK) modulation on the secondary SCH, and transmits the BPSK-modulated secondary SCH to the mobile station. The diversity information includes information on whether the base station has applied the transmit diversity to the BCH transmission.

The mobile station detects the diversity information from the secondary SCH and determines whether the transmit diversity is applied to a current BCH. When the transmit diversity is not applied, the mobile station demodulates the current BCH by using a conventional demodulation method or it demodulates the BCH by using the STBC method.

When the transmit diversity is applied, the base station transmits a different pilot symbol through each antenna. Accordingly, a BCH transmitted through a specific antenna and a BCH of the mobile station correspond to each other for the mobile station to receive a pilot transmitted through the specific antenna.

That is, conventionally, the mobile station receives the primary SCH to check base station information such as transmit power, phase, offset, and transmission rate, and receives the secondary SCH including channel estimation information for BCH demodulation, forward link data channel estimation information, and transmit diversity information. When the transmit diversity information is checked through the secondary SCH, the mobile station receives a BCH from the base station and matches the received BCH to a BCH of the mobile station. When the two BCHs are matched, the mobile station receives a pilot transmitted through the corresponding antenna from the base station. As described, the conventional method for receiving a pilot symbol from the base station with the transmit diversity has a drawback of complexity in receiving of the pilot symbol since the base station generates and transmits two SCHs and the mobile station receives the two SCHs and analyzes them.

In addition, typically, a base station applies transmit diversity and thus the base station uses one antenna, two antennas, or four antennas for transmitting an SCH, a BCH, and a pilot symbol.

As described, the number of antennas used by the base station varies, but it is difficult for the mobile station to identify the number of antennas of the base station by using the primary SCH and the secondary SCH. Accordingly, the mobile station checks whether the transmit diversity is applied in the cases that the base station has one antenna, two antennas, and four antennas, respectively, and then checks the number of antennas of the base station through the checking result.

As described, the mobile station checks whether the base station has applied transmit diversity by using two synchronization signals and demodulates the BCH by using the checking result, and therefore, time for checking the number of antennas of the base station and time for BCH demodulation and pilot receiving are increased, and an algorithm used for checking the number of antennas of the base station becomes complicated, thereby increasing power consumption.

### DISCLOSURE

### Technical Problem

The present invention has been made in an effort to provide a BCH demodulation method having advantages of prompt receiving of a pilot symbol and reduction of power consumption in an OFDM system with transmit diversity, and a transmitting apparatus and a receiving apparatus using the same. The BCH demodulation method is provided to a mobile station that receives a BCH and an SCH through the same antenna from a transmitting apparatus of a base station having a plurality of antennas, and demodulates the BCH by using the SCH. The base station locates the BCH and the SCH that are adjacent to each other, and transmits the SCH and the BCH through the same antenna by applying the same transmit diversity to the BCH and the SCH. The transmit diversity corresponds to one of TSTD, FSTD, and beam switching.

### Technical Solution

A method for transmitting a synchronization channel (SCH) and a broadcasting channel (BCH) according to an embodiment of the present invention is provided to a transmitting apparatus of a base station. The method includes: a) generating a BCH symbol and an SCH symbol to be transmitted; b) mapping the BCH symbol and the SCH symbol to an orthogonal frequency division multiplex (OFDM) signal so as to locate the BCH symbol and the SCH symbol in one sub-frame; and c) transmitting the BCH symbol and the SCH symbol through the same antenna by applying the same transmit diversity to the BCH symbol and the SCH symbol.

A transmitting apparatus of a base station of a mobile communication system according to another embodiment of the present invention transmits a BCH and an SCH, and includes: means for generating a BCH symbol for transmitting the BCH; means for generating an SCH symbol for transmitting the SCH; means for mapping the BCH symbol and the SCH symbol to an OFDM signal so as to locate the BCH symbol and the SCH symbol within one sub-frame; and means for transmitting the BCH symbol and the SCH symbol through the same antenna by applying the same transmit diversity to the BCH symbol and the SCH symbol.

A method for demodulating BCH according to another exemplary embodiment of the present invention is provided to a mobile station of a mobile communication system. The method includes: separating an SCH and a BCH from an OFDM signal received from a base station by filtering the BCH and the SCH; calculating a channel estimation value by using an SCH symbol included in the SCH; and coherently demodulating the BCH by using the calculated channel estimation value.

### DESCRIPTION OF DRAWINGS

FIG. 1 shows a forward link frame structure of an orthogonal frequency division multiplex (OFDM) system where the same diversity is applied to a synchronization channel (SCH) and a broadcasting channel (BCH) according to an exemplary embodiment of the present invention.

FIG. 2 shows a structure of a sub-frame including an SCH and a BCH according to the exemplary embodiment of the present invention, in detail.

FIG. 3 is a schematic block diagram of a transmitting apparatus of a base station according to the exemplary embodiment of the present invention.

FIG. 4 is a schematic block diagram of a receiving apparatus of a mobile station that receives an OFDM modulation signal from the base station by using one antenna, the OFDM modulation signal including an SCH and a BCH.

FIG. 5 is a schematic block diagram of a receiving apparatus of a mobile station, receiving an OFDM modulation signal from a base station by using two antennas according to another exemplary embodiment of the present invention, the OFDM modulation signal including an SCH and a BCH.

FIG. 6 shows an exemplary structure of an SCH symbol and a BCH symbol in an SCH allocation band according to the exemplary embodiment of the present invention.

FIG. 7 shows a structure of an OFDM modulation signal where an SCH symbol and a BCH symbol are alternated in an SCH allocation band according to another exemplary embodiment of the present invention.

FIG. 8 is a flowchart of a process for transmitting an SCH and a BCH by using the same transmit diversity.

FIG. 9 is a flowchart of a process for demodulating a BCH by using a received SCH according to the exemplary embodiment of the present invention.

### BEST MODE

An exemplary embodiment of the present invention will hereinafter be described in detail with reference to the accompanying drawings. In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise”, and variations such as “comprises” or “comprising”, will be understood to imply the inclusion of stated elements but not the exclusion of any other elements.

A synchronization channel (SCH) and a broadcasting channel (BCH) that are transmitted to a mobile station from a base station according to an exemplary embodiment of the present invention are included in an orthogonal frequency division multiplex (OFDM) modulation signal, and they are frequency-division multiplexed or time-division multiplexed with other channels.

In addition, the mobile station performs conventional basic functions such as OFDM symbol and frame timing detection in an initial power-on stage and initial frequency offset estimation by using the SCH, and uses the SCH for channel estimation when demodulating the BCH.

The SCH according to the exemplary embodiment of the present invention may further include a scrambling code identifier (ID) or a scrambling code group used for scrambling a pilot channel or a data channel by the base station, or frame boundary information that indicates one frame period.

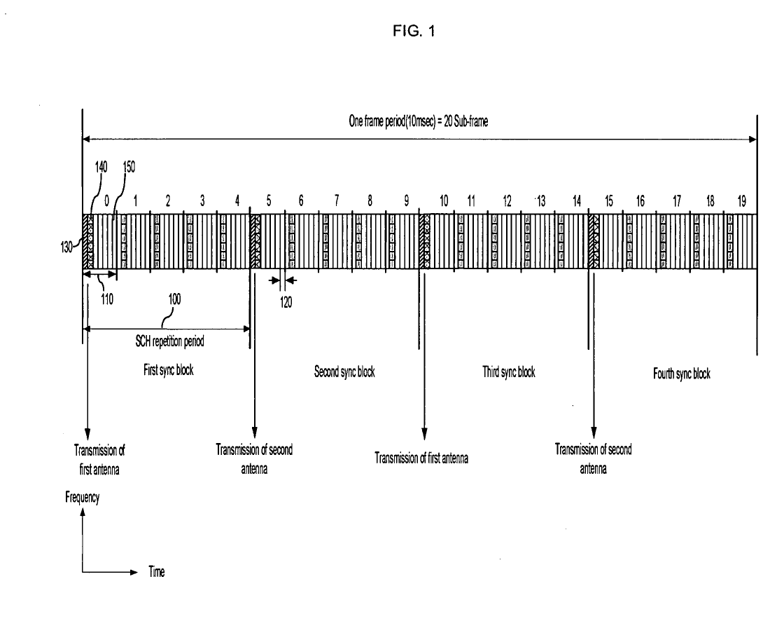

FIG. 1 shows a forward link frame structure of an OFDM system where the same transmit diversity is applied to an SCH and a BCH.

One forward link frame according to the exemplary embodiment of the present invention includes a plurality of sub-frames. In FIG. 1, one forward link frame is 10 msec and includes 20 sub-frames. In addition, the horizontal axis indicates the time axis and the vertical axis indicates the frequency (i.e. OFDM sub-carrier) axis.

The forward link frame of FIG. 1 transmits four synchronization channels per frame, and an interval between previous SCH transmission and the next SCH transmission is referred to as a synchronization (sync) block 100. Accordingly, one frame period includes four sync blocks, and each sync block includes five sub-frames 110.

Each of the sub-frames 110 is formed of a plurality of OFDM symbol periods 120. In FIG. 1, the sub-frame 110 has a length of 0.5 msec and includes 7 OFDM symbol periods 120. One sub-frame 110 is formed of an SCH symbol period 130, a pilot symbol period 140, and a plurality of data symbol periods 150. In this case, the SCH symbol period 130 may not be included.

A pilot symbol period 140 in a sub-frame that includes the SCH symbol period 130 includes a pilot symbol and a BCH symbol, and a pilot symbol period 140 in a sub-frame that does not include the SCH symbol period 130 includes forward link data symbols, excluding the BCH symbol and the SCH symbol.

A method for a receiving apparatus of the mobile station to coherently demodulate a BCH symbol by using an SCH symbol when time switched transmit diversity (TSTD) is equally applied to the SCH symbol and the BCH symbol will be described. For example, as shown in FIG. 1, among 20 sub-frames in the 10-msec frame, four sub-frames respectively include an SCH symbol period 130 and a pilot symbol period 140. That is, four SCH symbols are transmitted during one frame period. When the base station has two transmit antennas, SCH symbols and BCH symbols of the first sub-frame (i.e., sub-frame 0) and the third sub-frame (i.e., sub-frame 10), which include an SCH symbol period 140, are transmitted through a first antenna. In addition, the second sub-frame (i.e., sub-frame 5) and the fourth sub-frame (i.e., sub-frame 15) that include an SCH symbol period 140 are transmitted through a second antenna.

When the base station has four transmit antennas, the SCH symbol and the BCH symbol of the sub-frame 0 are transmitted through a first transmit antenna, the SCH symbol and the BCH symbol of the sub-frame 5 are transmitted through a second transmit antenna, the SCH symbol and the BCH symbol of the sub-frame 10 are transmitted through a third transmit antenna, and the SCH symbol and the BCH symbol of the sub-frame 15 are transmitted through a fourth transmit antenna.

A method for the receiving apparatus of the mobile station to coherently demodulate a BCH symbol by using an SCH symbol when frequency switched transmit diversity (FSTD) is equally applied to the SCH symbol and the BCH symbol will be described.

When the base station has two transmit antennas and the SCH or the BCH occupies N sub-carriers, a component corresponding to the even-numbered sub-carrier is transmitted through a first antenna and a component corresponding to the odd-numbered sub-carrier is transmitted through a second antenna.

When a beam switching method is applied, and four sub-frames among the 20 sub-frames of FIG. 1 respectively include an SCH and a BCH within one frame period, SCH symbols and BCH symbols of the first sub-frame (i.e., sub-frame 0 in FIG. 1) and the third sub-frame (i.e. sub-frame 10) that include an SCH symbol period 130 are transmitted through a first beam, and the SCH symbols and the BCH symbols of the second sub-frame (i.e., sub-frame 5) and the fourth sub-frame (i.e. sub-frame 15) that include an SCH are transmitted through a second beam.

Herein, “beam” indicates a signal generated by adding a specific weight vector to a plurality of antennas.

When four beams are provided, the SCH symbol and the BCH symbol of the first sub-frame are transmitted through a first beam, the SCH symbol and the BCH symbol of the second sub-frame are transmitted through a second beam, the SCH symbol and the BCH symbol of the third sub-frame are transmitted through a third beam, and the SCH symbol and the BCH symbol of the fourth sub-frame are transmitted through a fourth beam.

In this case, when an SCH and a BCH symbol are applied with the same transmit diversity, SCH symbols and BCH symbols existing within the same sub-frame must be transmitted through the same antenna. Herein, when an SCH symbol and a BCH symbol that neighbor each other can be transmitted through the same antenna, any transmit diversity can be applied.

According to the exemplary embodiment of the present exemplary embodiment, an SCH symbol period and a BCH symbol period neighbor are just next to each other on the time axis, but this is not restrictive. It is preferred that an SCH symbol period and a BCH symbol period are arranged to be adjacent enough so that the mobile station can coherently demodulate the BCH by using the SCH. In the present exemplary embodiment, an SCH and a BCH are arranged together within one sub-frame.

Through the above-described methods, the base station applies the same transmit diversity to an SCH symbol and a BCH symbol and transmits them through the same antenna such that the mobile station can coherently demodulate the BCH symbol by using the SCH symbol.

A BCH symbol is a forward link common broadcasting channel encoded to a message packet format and then transmitted. One message packet is transmitted every 10 msec. That is, a transmitting end of the base station generates one BCH message packet every 10 msec and encodes the generated BCH message packet. The BCH message packet is mapped to an OFDM symbol in the 10 msec frame as shown in FIG. 1 and transmitted on a forward link.

In this case, the OFDM symbol transmitted on the forward link is inverse-Fourier transformed and added with a cyclic prefix (CP) before transmission.

In this case, other periods, excluding the SCH symbol period 130, are respectively multiplied by a cell-specific long PN scrambling code before the IFFT operation so as to identify each cell.

When initial power is applied to the mobile station, the mobile station receives the forward link frame as shown in FIG. 1 from a base station of a cell in which the mobile station is located, and performs a cell search operation through system timing acquisition and long PN scrambling code checking.

The OFDM-modulated SCH is used for the cell search operation by the mobile station as well as for channel estimation for coherent demodulation of the BCH according to the exemplary embodiment of the present invention.

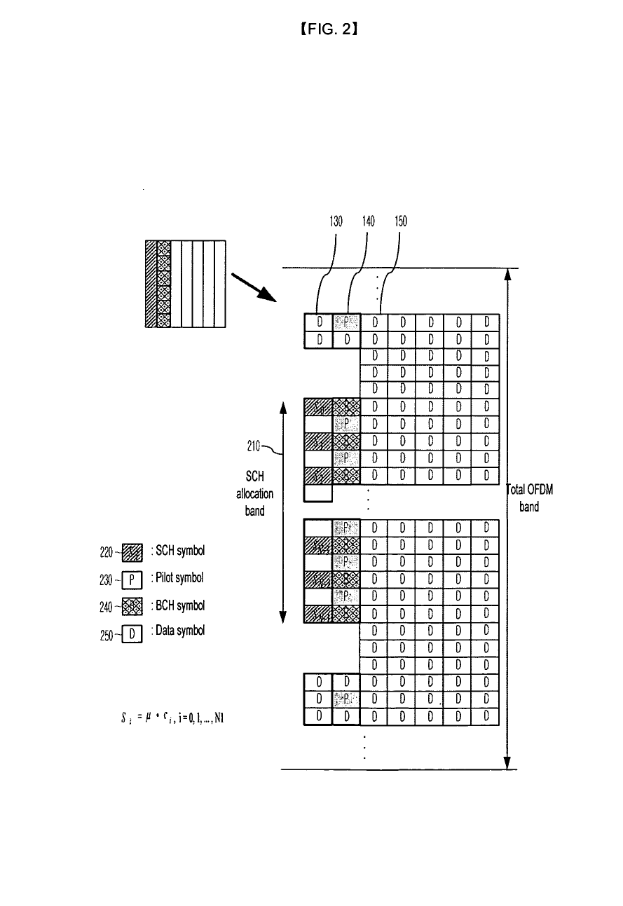

FIG. 2 shows a structure of a sub-frame including an SCH and a BCH according to the exemplary embodiment of the present invention in detail.

In the sub-frame frame structure, the SCH symbol period 130 may include a sub-carrier including an SCH symbol 220, a sub-carrier including a data symbol 250, and a sub-carrier including no symbol.

The SCH symbol 220 can be located only in a part of the SCH symbol period 130, and the part is called an SCH allocation band 210. In addition, the SCH symbol 220 may use all sub-carriers in the SCH allocation band 210 or partially use the sub-carriers.

The sub-frame structure illustrated in FIG. 2 occupies one of every two sub-carriers in the SCH allocation band 210, and the other neighboring sub-carrier is not used. When only one of every two sub-carriers is occupied, a differential correlator can be used for acquisition of OFDM symbol synchronization during a cell search process.

The SCH symbol 220 is scrambled by an SCH scrambling code in the frequency domain. When the number of sub-carriers occupied by each SCH symbol is N, a frequency domain signal transmitted to the SCH symbol can be represented in a vector form as given in Math Figure 1.

S=[S₀S₁S₂ . . . S_{N-1}] [Math Figure 1]

(where Sᵢ=μ·cᵢ, i=0, 1, . . . N−1)

In Math Figure 1, Sᵢ denotes a frequency domain signal component of an SCH symbol transmitted to the i-th sub-carrier among the N sub-carriers occupied by the SCH symbol 220, and corresponds to a product of an SCH symbol μ and the i-th constituent element of an SCH scrambling code. Herein, the SCH scrambling code is a complex code having the length of N, and can be represented as given in Math Figure 2.

c=[c₀c₁ . . . c_{N-1}] [Math Figure 2]

The SCH scrambling code may have the same code value at a plurality of SCH symbol locations within a frame, or may have different code values, respectively. In addition, neighboring cells may use the same SCH codes or may use different SCH codes.

In this case, the SCH symbol μ is a value that is equally multiplied by the respective N sub-carriers, and has a predetermined symbol value (e.g., 1 or (1+j)/\sqrt{2}). The mobile station of the OFDM system according to the exemplary embodiment of the present invention must be aware of the value of μ in advance.

The pilot symbol period 140 includes a sub-carrier including a pilot symbol 230 or a BCH symbol 240, and may also include a sub-carrier including a data symbol 250 as well. Herein, the pilot symbol 230 is included in a sub-carrier located in the SCH allocation band 210.

In addition, the BCH symbol 240 includes system information containing a number of a sub-frame 110 and a bandwidth used by the system. The BCH symbol 240 is located just next to the SCH symbol 220 on the time axis. Therefore, the mobile station can minimize channel estimation error due to radio channel fading that can be generated depending on a moving speed of the mobile station when coherently demodulating a BCH by using a channel estimation value of an SCH.

When the same transmit diversity, such as the TSTD, the FSTD, and the beam switching, is applied to an SCH and a BCH and thus an SCH symbol and a BCH symbol are transmitted through the same antenna, cell search performance of the mobile station can be significantly improved. In addition, when the mobile station demodulates and decodes the BCH, a BCH frame error probability can be maintained at a low level. In addition, an SCH and a BCH include in the same sub-frame are set to be transmitted through the same antenna such that the mobile station can coherently demodulate the BCH by using a channel estimation value of the SCH, thereby maximizing BCH demodulation performance.

Conventionally, a space time block code (STBC) method is applied to the BCH as transmit diversity, and in this case, a similar BCH demodulation method is used both when the base station has 1 transmit antenna and when the base station has 2 transmit antennas. However, the mobile station can use the same BCH modulation method without regarding the number of transmit antennas of the base station according to the exemplary embodiment of the present invention.

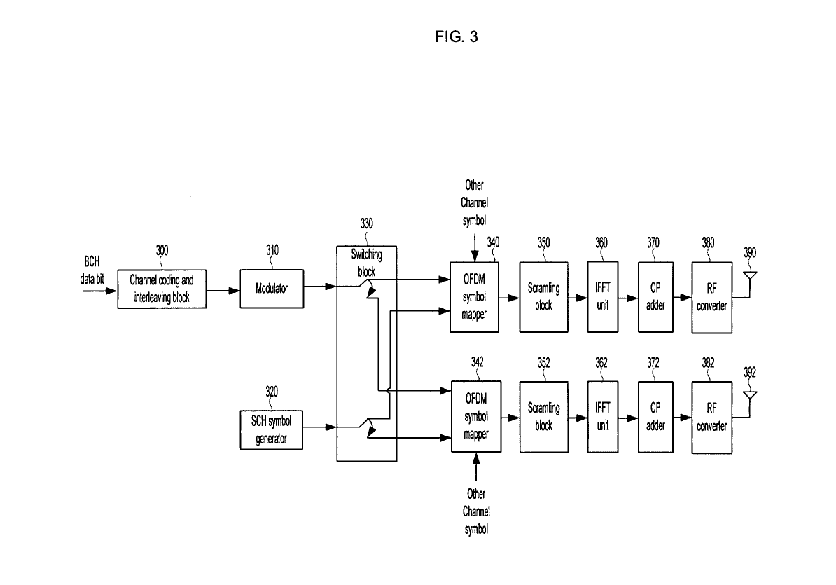

FIG. 3 is a schematic block diagram of a transmitting apparatus of the base station according to the exemplary embodiment of the present invention.

The transmitting apparatus of the base station according to the exemplary embodiment of the present invention includes a channel coding and interleaving block 300, a modulator 310, an SCH symbol generator 320, a switching block 330, OFDM symbol mappers 340 and 342, scrambling blocks 350 and 352, inverse fast Fourier transform (IFFT) units 360 and 362, CP inserting units 370 and 372, radio frequency converters 380 and 382, and antennas 390 and 392.

A BCH data bit is generated in an upper layer every 10 msec in the transmitting apparatus of the base station. The channel coding and interleaving block 300 receives the BCH data bit, performs channel coding on the BCH data bit, and interleaves the channel-coded BCH data bit in the time and frequency domains. The modulator 310 performs quadrature phase shift keying (QPSK) or BPSK modulation on an output of the channel coding and interleaving block 300, and the modulated output of the modulator 310 is input to the switching block 330.

In this case, a frequency domain symbol vector output from the modulator 310 is divided into the number of sub-frames in which a BCH is included. That is, as shown in FIG. 1, when the forward link frame of the OFDM system has the 10 msec frame period, the number of sub-frames having a BCH is 4, and each of the four sub-frames has N BCH symbols 240, 4N BCH symbols are transmitted for the 10 msec frame period, and the modulator 310 divides the 4N BCH symbols by 4 and outputs N BCH symbols from every one of the four sub-frames (i.e., sub-frame 0, sub-frame 5, sub-frame 10, and sub-frame 15).

The SCH symbol generator 320 outputs N SCH symbols from every one of sub-frames including an SCH. Herein, the N SCH symbols are defined as given in Math Figure 1. As previously described, the SCH symbols 220 transmitted from the sub-frames respectively including the SCH can be scrambled by using the same SCH scrambling code or scrambled by using different SCH codes.

The switching block 330 performs a switching operation after transmitting the last OFDM symbol period of each of the four sub-frames (sub-frame 0, sub-frame 5, sub-frame 10, and sub-frame 15) respectively including the SCH symbol 220 and the BCH symbol 240. That is, an antenna through which the SCH symbol 220 and BCH symbol 240 are transmitted is switched to another antenna for every sub-frame in which the SCH and the BCH are included.

According to the switching operation of the switching block 330, the transmitting apparatus of the base station having 2 transmit antennas transmits the sub-frame 0 through the first antenna 390, transmits the sub-frame 5 through the second antenna 392, transmits the sub-frame 10 through the first antenna 390, and transmits the sub-frame 15 through the second antenna 392, as shown in FIG. 3.

That is, according to the switching operation of the switching block 330, a sub-frame is transmitted either to the first OFDM symbol mapper 340 or to the second OFDM symbol mapper 342, and is transmitted to the mobile station either through the first antenna 390 or through the second antenna 392. The following description will be focused on the sub-frame that is passed through the first OFDM symbol mapper 340 and transmitted through the first antenna 390 by the switching block 330.

An output of the switching block 330 is mapped to OFDM symbols in the time and frequency domains as shown in FIG. 2 by the OFDM symbol mapper 230, and is frequency-division multiplexed or time-division multiplexed with other channels.

An output of the OFDM symbol mapper 340 is scrambled by a cell-specific scrambling code. The scrambling block 350 performs data scrambling on other channels, excluding the SCH symbol 220. The data scrambling is performed to maximize data demodulation performance of the mobile station by randomizing interference between neighboring cells. When the data scrambling is performed on an SCH symbol, initial cell search performance can be degraded, and therefore the scrambling block 350 does not scramble the SCH symbol 220.

An output of the scrambling block 350 is transformed into a time domain signal by the IFFT unit 360. In addition, the CP inserting unit 370 inserts a CP to the head of the OFDM modulation signal that has been transformed into the time domain signal.

The CP-inserted OFDM modulation signal is converted into a radio frequency (RF) signal and filtered by the radio frequency converter 380. The radio frequency converter 380 includes an up-converter, an amplifier, and a filter. The OFDM modulation signal that has been converted into the RF signal by the radio frequency converter 380 is transmitted to the mobile station through the first antenna 390.

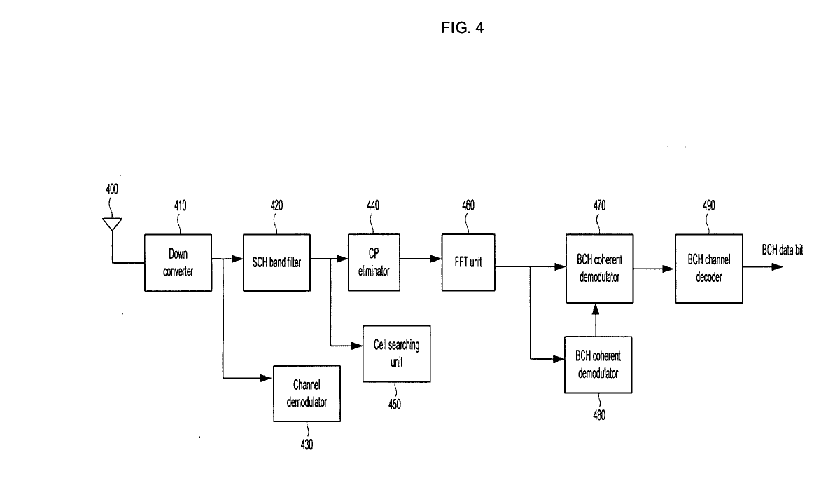

FIG. 4 is a block diagram of a receiving apparatus of the mobile station that receives the OFDM modulation signal that includes an SCH and a BCH that are transmitted from the base station by using one antenna according to the exemplary embodiment of the present invention.

A receiving apparatus of the mobile station receives an SCH and a BCH by using one antenna, and includes a receive antenna 400, a down-converter 410, an SCH band filter 420, a channel demodulator 430, a CP eliminator 440, a cell searching unit 450, a fast Fourier transform (FFT) unit 460, a channel estimator 480, a BCH coherent demodulator 470, and a BCH channel decoder 490.

The receive antenna 400 receives an OFDM modulation signal from the base station and delivers the received OFDM modulation signal to the down-converter 410, and the down-converter 410 converts the OFDM modulation signal that has been converted into an RF signal into a baseband signal.

The OFDM modulation signal that has been converted into the baseband signal is delivered to the SCH band filter 420 and the channel demodulator 430, and the SCH band filter 420 filters only an SCH and a BCH included in the SCH allocation band 210 from the OFDM modulation signal. Other channels, excluding the SCH and the BCH, in the OFDM modulation signal are delivered to the channel demodulator 430 and demodulated by the channel demodulator 430.

The SCH filtered by the SCH band filter 420 is transmitted to the cell searching unit 450. The cell searching unit 450 performs a cell search operation by using the filtered SCH. Herein, the cell search operation includes initial synchronization, frequency offset correction, and cell scrambling code checking.

The SCH and BCH filtered by the SCH band filter 420 are transmitted to the CP eliminator 440 so that the CPs inserted to the head of the SCH and the BCH are eliminated. The CP-eliminated SCH and BCH are transformed into frequency domain signals from the time domain signals by the FFT unit 460.

In this case, a signal received at a sub-carrier location of the i-th SCH at a location of an SCH symbol of a sub-frame including the SCH and the BCH among output signals of the FFT unit 460 can be represented as given in Math Figure 3.

$$\begin{matrix}{r}_{i}^{( s )} = {α}_{i} {S}_{i} + {n}_{i} \\ = {α}_{i} μ {c}_{i} + {n}_{i}\end{matrix} \qquad [ Math Figure 3 ]$$

where nᵢ denotes additive Gaussian Noise (AGN), and αᵢ denotes channel distortion of a radio channel.

A signal received at a location of a sub-carrier of the i-th BCH at a location of a BCH symbol of the sub-frame including the SCH and the BCH among the output signals of the FFT unit 460 can be represented as given in Math Figure 4.

rᵢ^{(B)}=αᵢdᵢpᵢ+nᵢ′ [Math Figure 4]

where nᵢ′ denotes AGN, dᵢ denotes a BCH data symbol, and pᵢ denotes the i-th constituent element of a cell scrambling code.

The channel estimator 480 estimates a channel from the output signals that can be represented as given in Math Figure 3 and Math Figure 4 of the FFT 460.

In this case, an SCH and a BCH that are located adjacent to each other in the time axis and occupy the same sub-carrier have almost the same channel distortion. By using this characteristic, the mobile station estimates a channel distortion value αᵢ by using the SCH symbol of Math Figure 3 and coherently demodulates a received value of the BCH symbol of Math Figure 4 to thereby estimate a value of dᵢ.

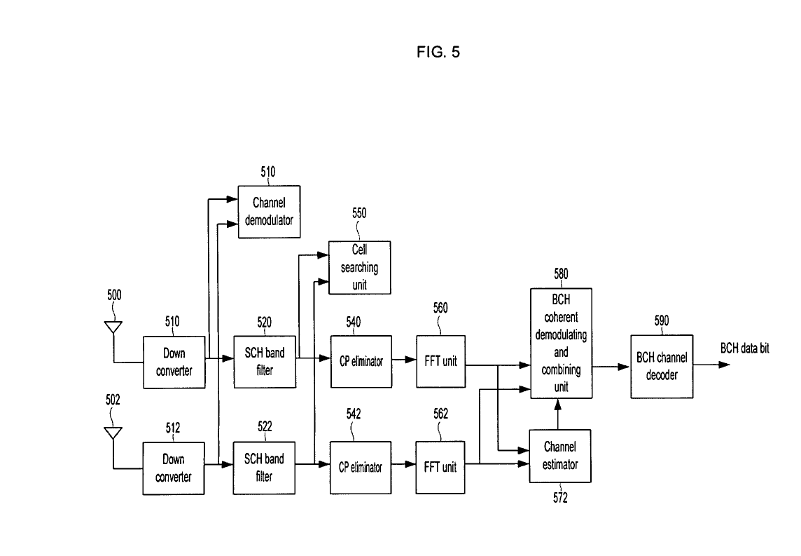

The channel estimator 480 estimates a channel from the synchronization signal output from the FFT unit 460 by using Math Figure 5.

\hat{α}ᵢ=rᵢ^{(S)}·μ*cᵢ* [Math Figure 5]

wherein * denotes a complex conjugate. Herein, the mobile station must be aware of a value of μ and a value of cᵢ in advance.

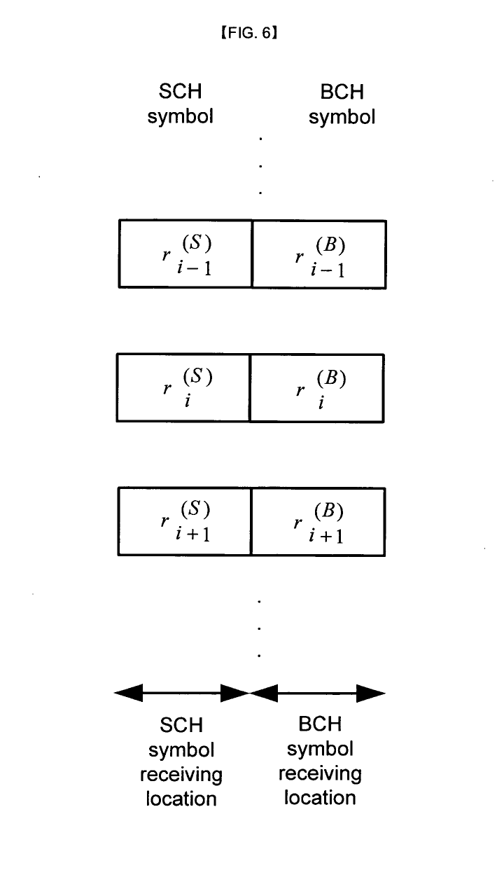

The BCH coherent demodulator 470 coherently demodulates a BCH by using a channel estimation value output from the channel estimator 480. The BCH coherent demodulator 470 coherently demodulates the BCH by using the channel estimation value calculated from Math Figure 5. In this case, a zero forcing equation is used to coherently demodulate the BCH as given in Math Figure 6.

\hat{d}ᵢ=rᵢ^{(S)}pᵢ*/\hat{α}ᵢ [Math Figure 6]

In this case, the mobile station must be aware of a value of pᵢ in advance so as to coherently demodulate the BCH as given in Math Figure 6.

The BCH that has been coherently demodulated through Math Figure 6 is decoded by the BCH channel decoder 490 and outputted.

FIG. 5 is a schematic block diagram of a receiving apparatus of a mobile station according to another exemplary embodiment of the present invention. The receiving apparatus receives OFDM modulation signals, each including an SCH and a BCH from the base station by using two antennas.

The receiving apparatus of the mobile station includes two receive antennas 500 and 502, two down-converters 510 and 512, two SCH band filters 520 and 522, a channel demodulator 530, two CP eliminators 540 and 543, a cell searching unit 550, two FFT units 560 and 562, a BCH coherent demodulating and combining unit 580, and a BCH channel decoder 590.

The channel demodulator 530 receives channels from a first OFDM modulation signal received through the first antenna 500 and channels from a second OFDM modulation signal received through the second antenna 502, and demodulates the received channels, the first and second OFDM modulation signals having been converted into baseband signals by the first and second down-converters 510 and 512, respectively. In this case, SCHs and BCHs included in the first and second OFDM modulation signals are excluded.

The cell searching unit 550 performs a cell search operation by using an SCH transmitted from the first SCH band filter 520 or the second SCH band filter 522. The cell searching operation includes initial synchronization of the base station that has transmitted the respective OFDM modulation signals, offset correction, and cell scrambling code checking.

The channel estimator 572 estimates a channel for the first receive antenna 500 by using an SCH symbol output from the first FFT unit 560, and estimates a channel for the second receive antenna 502 by using an SCH symbol output from the second FFT unit 562. In this case, each channel is estimated through Math Figure 5, and each of the estimated channels is delivered to the BCH coherent demodulating and combining unit 580.

The BCH coherent demodulating and combining unit 580 coherently demodulates a BCH for each receive antenna path and performs combining.

FIG. 6 shows an exemplary structure of an SCH and a BCH in an SCH allocation band according to the exemplary embodiment of the present invention.

As previously described, in order to minimize a channel estimation error due to radio channel fading that can be generated depending on the moving speed of the mobile station during BCH coherent demodulation, the BCH symbol 240 of the OFDM modulation signal transmitted to the mobile station from the base station is located just next to the SCH symbol 220 on the time axis.

Accordingly, the mobile station can coherently demodulate the BCH symbol 240 by using a channel estimation value of the SCH symbol 220 located just next to the BCH symbol 240.

However, it is possible to design the SCH symbol 220 and the BCH symbol 240 in an OFDM modulation signal transmitted from the base station to be alternated for realization of the present invention.

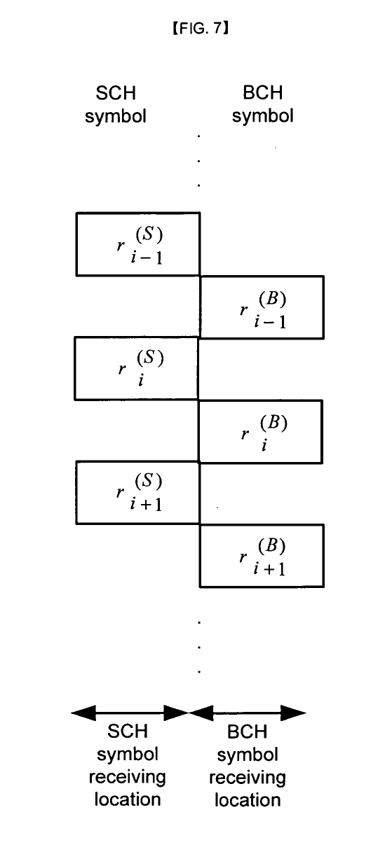

FIG. 7 shows an alternated structure of an SCH symbol and a BCH symbol of an OFDM modulation signal in an SCH allocation band according to another exemplary embodiment of the present invention.

When an SCH symbol 220 and a BCH symbol 240 are alternated by one sub-carrier as shown in FIG. 7, the mobile station calculates channel estimation values for two neighboring SCH symbols 220 in the frequency domain by using an interpolation method, and the channel estimation value is used to demodulate a BCH to thereby coherently demodulate the BCH symbol 240.

That is, in the OFDM modulation signal structure of FIG. 7, the mobile station estimates a channel estimation value for an SCH symbol denoted as and a channel estimation value for an SCH denoted as rᵢ₊₁^{(S)} so as to coherently demodulate the BCH symbol 240 denoted as rᵢ^{(B)}. In addition, a channel estimation value for demodulation of a BCH symbol denoted as rᵢ^{(B)} is calculated by using two channel estimation values estimated by using the interpolation method, and the BCH symbol is coherently demodulated by using the channel estimation values.

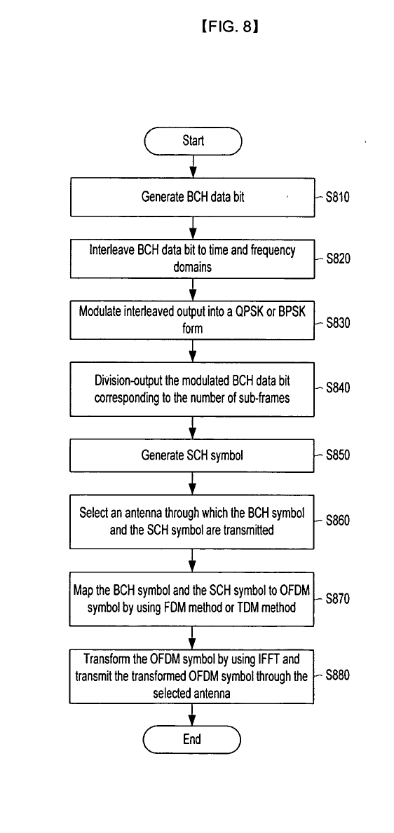

FIG. 8 is a flowchart of an SCH and BCH transmission process using the same transmit diversity according to the exemplary embodiment of the present invention.

A transmitting apparatus of a base station generates a BCH data bit through an upper layer, in step S810.

The transmitting apparatus performs channel coding on the BCH data bit by using the channel coding and interleaving block 300, and performs interleaving on the channel-coded BCH data bit to the time and frequency domains, in step S820.

The interleaved BCH data bit is modulated in the form of QPSK or BPSK by the modulator in step S830, and is divided into the number of sub-frames that include a BCH symbol. The divided BCH data bits are respectively included in each sub-frame, in step S840.

In step S850, an SCH is generated by the SCH symbol generator 320. The SCH includes initial synchronization of the base station, frequency offset correction information, and cell scrambling code information.

The base station includes a plurality of antennas, and selects a transmit antenna by using a switching block 330 so as to transmit a BCH and an SCH by using transmit diversity. In this case, it is preferred that the switching block 330 sequentially selects the plurality of antennas, but the switching block 330 may randomly select one of the plurality of antennas, in step S860.

When the transmit antenna is selected, a BCH symbol and an SCH symbol are mapped to OFDM symbols in the time and frequency domains by the OFDM symbol mapper 340 and 342. In this case, the SCH and the BCH may be frequency-division multiplexed or time-division multiplexed, in step S870.

The OFDM symbols are scrambled by the scrambling blocks 350 and 352 and converted into time domain signals by the IFFT units 360 and 362. Then, a CP is inserted in front of each time domain signal, and the CP-inserted time domain signals is modulated to radio frequency signals the radio frequency converters 380 and 382 and transmitted to the mobile station, in step S880.

According to the above-described processes, the transmitting apparatus of the base station transmits the SCH and the BCH to the mobile station by using the transmission diversity.

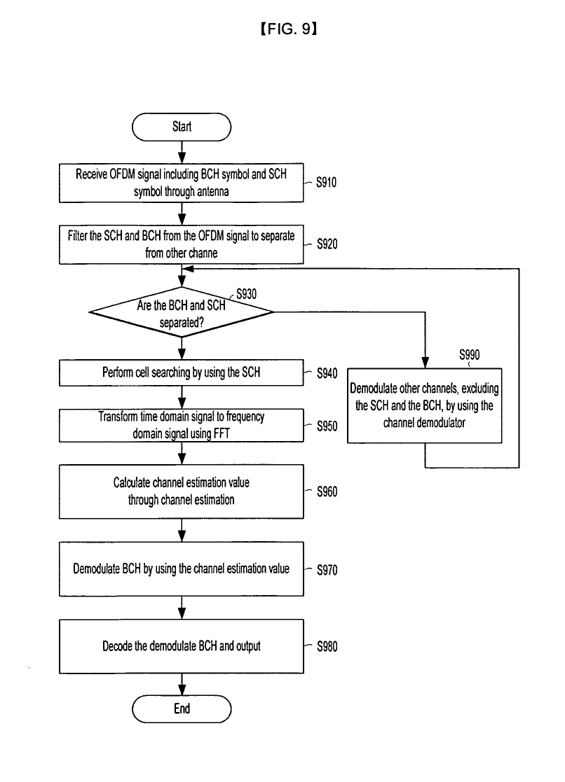

FIG. 9 is a flowchart of a BCH demodulation process using a received SCH according to the exemplary embodiment of the present invention.

When an OFDM signal including an SCH is transmitted from the transmitting apparatus of the base station, the mobile station receives the OFDM signal through an antenna. When the mobile station has a plurality of antennas, the mobile station may use a specific antenna for receiving the OFDM signal, or may sequentially use the plurality of antennas for receiving the OFDM signal, in step S910.

The mobile station converts the received OFDM signal into a baseband signal, and an SCH and a BCH are separated from other channels by filtering the SCH and the BCH from the converted OFDM modulation signal, in step S920.

When the SCH and the BCH are separated in step S930, the mobile station performs a cell search operation by checking information included in the SCH, in step S940. The information includes initial synchronization information of the base station, frequency offset correction information, and cell scrambling code information.

Then, CPs inserted to the heads of the SCH and the BCH are eliminated, and the time domain signals are transformed into frequency domain signals by the FFT unit 460, in step S950.

Then, channels for the SCH and the BCH that have been converted into the frequency domain signals are estimated. In this case, channel estimation values of the SCH and the BCH can be calculated by using Math Figure 3 and Math Figure 4, in step S960.

When the channel estimation values are calculated, the BCH is coherently demodulated by using the zero forcing equation. In the case that the mobile station receives OFDM signals by using a plurality of antennas, channel estimation values for an SCH and a BCH of each OFDM signal received through each of the antennas are individually calculated, and a combining process may be additionally performed, in step S970.

The coherently demodulated BCH is decoded by the BCH channel decoder 590, and is then output as a BCH data bit, in step S980.

In step S920, other channels separated from the SCH and the BCH of the OFDM signal are transmitted to the channel demodulators 430 and 530, and respectively demodulated by them, in step S990.

Through the above-described processes, the mobile station can demodulate a BCH by using one SCH included in an OFDM signal transmitted from the base station.

The above-described exemplary embodiments of the present invention can be realized not only through a method and an apparatus, but also through a program that can perform functions corresponding to configurations of the exemplary embodiments of the present invention or a recording medium storing the program, and this can be easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

According to the present invention, an SCH and a BCH are located adjacent to each other, and the SCH and the BCH are transmitted through the same antenna by applying the same transmit diversity such as TSTD, FSTD, and beam switching to the SCH and the BCH such that cell search performance of the mobile station can be improved by reducing time for checking the number of antennas of the base station and time for BCH demodulation, thereby reducing power consumption. In addition, the mobile station can use the same BCH demodulation method without regarding the number of antennas of the base station.

In addition, the mobile station coherently demodulates the BCH by using the SCH so that BCH demodulation performance can be maximized, a BCH frame error generation probability can be reduced, and a channel estimation error due to radio channel fading that can be generated depending on the moving speed of the mobile station can be minimized.

1. A method for transmitting a synchronization channel (SCH) and a broadcasting channel (BCH) in a transmitting apparatus of a base station, the method comprising:
a) generating a BCH symbol and an SCH symbol to be transmitted;
b) mapping the BCH symbol and the SCH symbol to an orthogonal frequency division multiplex (OFDM) signal so as to locate the BCH symbol and the SCH symbol within one sub-frame; and
c) transmitting the BCH symbol and the SCH symbol through the same antenna by applying the same transmission diversity to the BCH symbol and the SCH symbol.

2. The method of claim 1, wherein the transmit diversity corresponds to one of time switching transmit diversity (TSTD), frequency switched transmit diversity (FSTD), and beam switching.

3. The method of claim 1, wherein, in (b), a frequency division multiplex (FDM) method is used to map each of the BCH symbol and the SCH symbol, and a time division multiplex (TDM) method is used to map between the BCH symbol and the SCH symbol.

4. The method of claim 1, wherein in (b), the BCH symbol is mapped to be located just before or just after the SCH symbol on the time axis.

5. The method of claim 1, wherein in (b), the BCH symbol and the SCH symbol are mapped to be located in the same frequency band on the frequency axis or alternated with each other by one sub-carrier.

6. A transmitting apparatus for transmitting a synchronization channel (SCH) and a broadcasting channel (BCH) in a base station of a mobile communication system, the transmitting apparatus comprising:
means for generating a BCH symbol for transmitting the BCH;
means for generating an SCH symbol for transmitting the SCH;
means for mapping the BCH symbol and the SCH symbol to an OFDM signal so as to locate the BCH symbol and the SCH symbol within one sub-frame; and
means for transmitting the BCH symbol and the SCH symbol through the same antenna by applying the same transmit diversity to the BCH symbol and the SCH symbol.

7. The transmitting apparatus of claim 6, wherein the same transmit diversity corresponds to one of time switched transmit diversity (TSTD), frequency switched transmit diversity (FSTD), and beam switching.

8. The transmitting apparatus of claim 6, wherein the means for mapping maps each of the BCH symbol and the SCH symbol by using a frequency division multiplexing (FDM) method and maps between the BCH symbol and the SCH symbol by using a time division multiplexing (TDM) method.

9. A method for demodulating a broadcasting channel (BCH) in a mobile station of a mobile communication system, the method comprising:
separating a broadcasting channel (BCH) and a synchronization channel (SCH) from an orthogonal frequency division multiplex (OFDM) signal received from a base station by filtering the BCH and the SCH;
calculating a channel estimation value by using an SCH symbol included in the SCH; and
coherently demodulating the BCH by using the calculated channel estimation value.

10. The method of claim 9, wherein the separated SCH is represented as given in the following math figure:
$$\begin{matrix}{r}_{i}^{( s )} = {α}_{i} {S}_{i} + {n}_{i} \\ = {α}_{i} μ {c}_{i} + {n}_{i}\end{matrix}$$
(where αᵢ denotes channel distortion, nᵢ denotes noise, Sᵢ denotes a frequency domain signal component of the SCH transmitted on the i-th sub-carrier, μ denotes the SCH symbol, and cᵢ denotes the i-th constituent element of an SCH scrambling code).

11. The method of claim 9, wherein the separated BCH is represented as given in the following math figure:
rᵢ^{(B)}=αᵢdᵢpᵢ+nᵢ′
(where dᵢ denotes the BCH symbol, pᵢ denotes the i-th constituent element of a cell scrambling code, and nᵢ′ denotes additive Gaussian noise).

12. The method of claim 10, wherein the channel estimation value is calculated by using the following math figure:
\hat{α}ᵢ=rᵢ^{(S)}·μ*cᵢ*
(where * denotes a complex conjugation).

13. The method of claim 12, wherein the coherent demodulating of the BCH coherently demodulates the BCH by using the following zero forcing equation:
\hat{d}ᵢ=rᵢ^{(S)}pᵢ*/\hat{α}ᵢ.

14. The method of claim 9, wherein in the OFDM signal, the BCH symbol is located just before or just after the SCH symbol on the time axis, located within the same frequency band as the SCH symbol on the frequency axis, or located to be alternated with the SCH symbol by one sub-carrier.

15. The method of claim 14, wherein when the BCH symbol is located to be alternated with the SCH symbol, channel estimation values for two SCH symbols adjacent to the BCH symbol on the frequency axis are calculated by using an interpolation method such that a channel estimation value for the coherent demodulating of the BCH is calculated.

16. The method of claim 9, wherein the calculating of the channel estimation value calculates a channel estimation value for each antenna by using an SCH symbol received through each antenna.

17. The method of claim 16, wherein the coherent demodulating of the BCH coherently demodulates a BCH of each OFDM signal by using the channel estimation value for each antenna and combines the demodulated BCHs.

18. The method of claim 9, further comprising, between the separating of the SCH and the BCH and the calculating of the channel estimation value, performing a cell search operation by using the filtered SCH.

19. The method of claim 9, further comprising, after the separating of the SCH and the BCH, demodulating other channels included in the OFDM signal, excluding the BCH and the SCH.
